(19) United States
(12) Patent Application Publication
(10) Pub. No.: US 2015/0182914 A1
(43) Pub. Date: Jul. 2, 2015

(54) APPARATUS AND METHOD FOR MEMBRANE ELECTROLYSIS RECYCLING OF PROCESS CHEMICALS

(71) Applicant: Exergy Technologies Corporation, Irvine, CA (US)

(72) Inventor: Fred P. Reinhard, Mission Viejo, CA (US)

(21) Appl. No.: 14/527,576

(22) Filed: Oct. 29, 2014

Related U.S. Application Data
(62) Division of application No. 10/645,132, filed on Aug. 21, 2003, now abandoned.
(60) Provisional application No. 60/405,132, filed on Aug. 21, 2002.

(51) Int. Cl. B01D 61/46

(52) U.S. Cl. CPC B01D 61/46; B01D 2325/42

(57) ABSTRACT

According to one embodiment, an membrane electrolysis (ME) unit is configured with a first cell frame, a second cell frame each having a compartment. The collective compartments of these cell frames houses an anode, a cathode, a first membrane positioned between the anode and the cathode, and a plurality of screen spacers. A first screen spacer is positioned between the anode and the first membrane while a second screen spacer is positioned between the cathode and the first membrane.

This application is a divisional of U.S. patent application Ser. No. 10/645,132, filed Aug. 21, 2003, and is based upon and claims the benefit of priority on U.S. Provisional Patent Application No. 60/405,132 filed Aug. 21, 2002, the entire contents of both of which are incorporated by reference.

### FIELD

The invention relates to the field of membrane electrolysis.

### GENERAL BACKGROUND

Currently, a conventional membrane electrolysis (ME) system features two or more cell frames separated by anion and cation selective membranes with spacers between cell frames and membranes. These ME systems are used for electrodialytic purification of process solutions and electrochemical generation of chemicals and normally include ion exchange membranes. Examples of such ion exchange membranes are set forth in U.S. Pat. Reissue No. 24,865.

### BRIEF DESCRIPTION OF THE DRAWINGS

The features and advantages of the invention will become apparent from the following detailed description of the invention in which:

FIG. 1A is a first exemplary embodiment of a membrane electrolysis (ME) system for process chemical recovering and/or recycling.

FIG. 1B is a second exemplary embodiment of a ME system.

FIG. 2 is a first exemplary embodiment of an ME unit of FIG. 1 associated with the ME system of FIG. 1A or 1B.

FIG. 3 is an embodiment of a cell frame of FIG. 2.

FIG. 4 is an exemplary embodiment of the ME unit of FIG. 2 implemented with a clamping unit.

FIG. 5 is an exemplary embodiment of an expanded metal screen cathode of the ME unit of FIG. 2.

FIG. 6 is a second exemplary embodiment of the ME unit of FIG. 1.

FIG. 7 is a third exemplary embodiment of the ME unit having multiple cells.

### DETAILED DESCRIPTION

Herein, an exemplary embodiment of the invention relates to a membrane electrolysis (ME) unit and improved operations thereof. According to one embodiment, the ME unit is configured to recover chemical elements. According to another embodiment, the ME unit is configured to remove one or more chemical elements (or impurities) from a process solution. The later embodiment is used for recycling purposes.

Herein, the embodiments described are not exclusive; rather, they merely provide a thorough understanding of the invention. Also, well-known elements are not set forth in detail in order to avoid unnecessarily obscuring the invention.

In the following description, certain terminology is used to describe features of the invention. For example, a “spacer” is generally defined as a device that provides a defined distance between adjacent membranes or a membrane and electrode for liquid to flow or move therebetween. Normally, the spacer is non-conductive. A “membrane” is generally defined as a thin section of material that allows chemicals of a certain chemical composition to migrate from one side to another, while other chemical compositions are precluded from passing through the material.

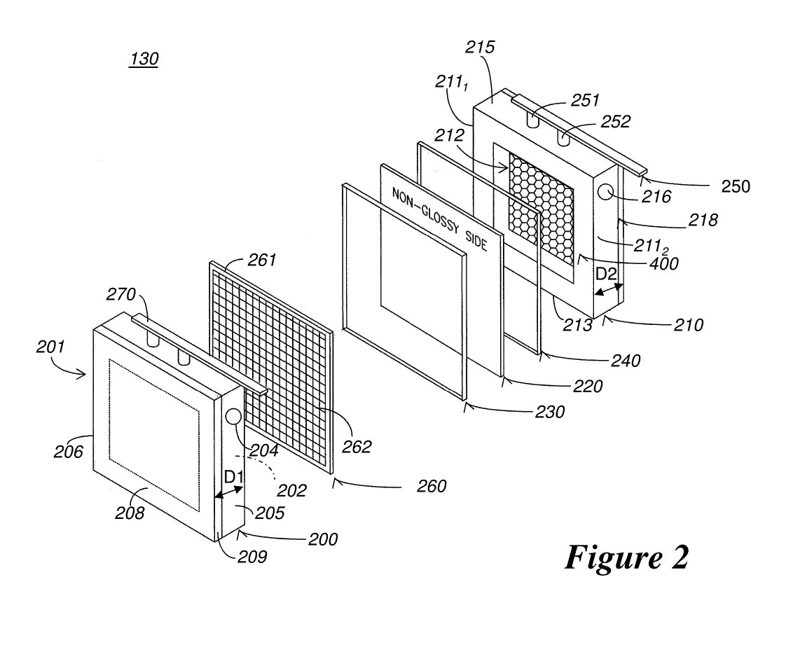

Functional efficiencies associated with implementation of the ME unit of FIGS. 2-6 into a ME system are numerous and only some are described herein. For instance, the ME unit enhances cell efficiency by minimizing a distance between electrodes and one or more membranes. This is due to the fact that thinner cell frames are more sensitive to mechanical charge. A minimum cell frame thickness is provided to effectively hold the inserted electrode and provide enough width for inflow and outflow ports having a diameter ranging from ¼″ to ¾″.

Also, the ME unit provides improved mass transfer characteristics by minimizing a distance between electrodes and the membrane sheets and/or implementing expanded metal electrodes and specific screen spacers as described herein. Screen spacers and small distances between electrodes and the membrane enhance electrolytic conductance and increase the liquid linear velocity in the cell, thus increasing the overall mass transfer efficiency. Other functional efficiencies may include one or more of the following: (1) eliminating off-gassing hazards, (2) improving cell seal properties, (3) improving temperature expansion properties of spacer materials (a major cause of leakage in ME systems) and (4) providing more flexibility to design, fabrication and application of ME systems.

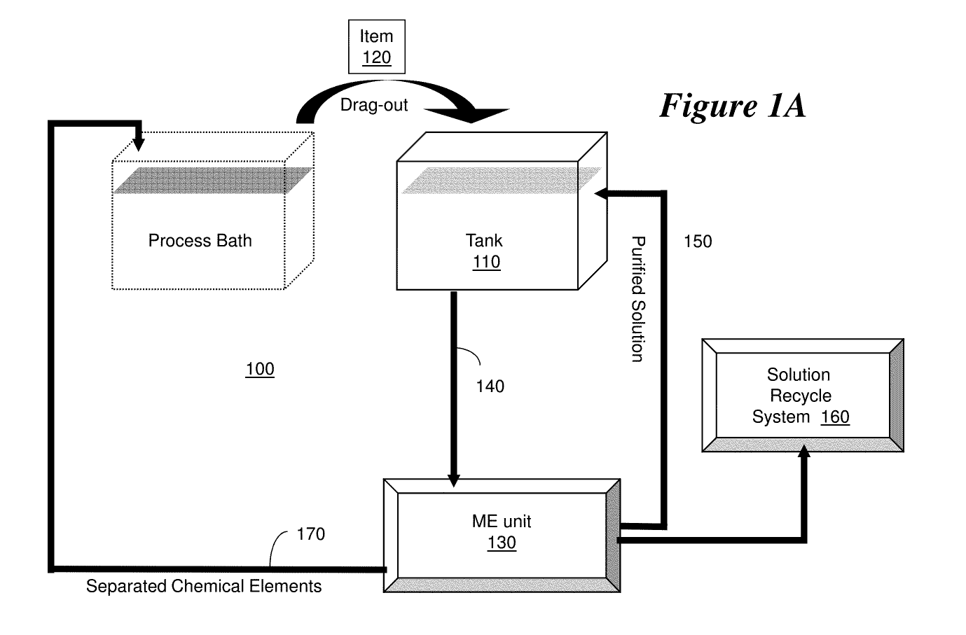

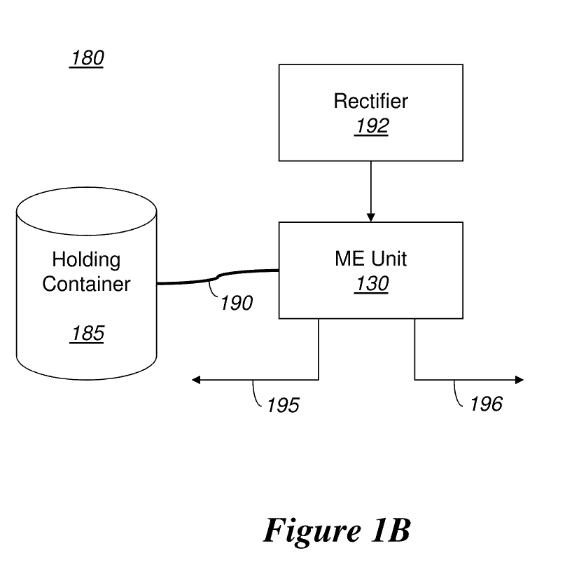

Referring to FIG. 1A, an exemplary embodiment of an in-line ME system 100 for process chemical recovery and/or recycling is shown. The ME system 100 comprises a tank 110 that receives an item 120 for removal of excessive chemicals and/or contaminants (hereinafter referred to as “chemical elements”). Examples of chemical elements include any type of ion, inclusive of non-metals and metals (e.g., Nickel “Ni”, Zinc “Zn”, Cadmium “Cd”, Chromium “Cr”, Silver “Ag”, Gold “Au”, Platinum “Pt”, etc.).

The tank 110 is coupled to a membrane electrolysis (ME) unit 130. Each cell of the ME unit 130 receives process solution 140 contained in the tank 110 and routes the process solution 140 to designated holding containers. For one embodiment of the invention, the process solution 140 is an aqueous solution with a concentration of excess chemical elements. For another embodiment of the invention, the process solution 140 is a non-aqueous solution with excess chemical elements.

For instance, in the embodiment as shown, the ME unit 130 separates chemical elements (e.g., ionic impurities) within the process solution 140 and returns a purified solution to tank 110 through a process line 150. This “process line” involves any mechanism that assists in the transfer of fluid, inclusive or exclusive of conduits.

Alternatively or in addition to providing the purified solution to the tank 110, ME unit 130 may provide selected chemical elements that may be provided for recycling purposes 160. Alternatively, in lieu of returning the chemical elements for recycling purposes, in some cases, the recovered chemical elements (ionic impurities) may be returned to a stage preceding the tank 110 via a process line 170. These chemical elements may be reused for transfer application such as coating or plating.

Referring to FIG. 1B, an exemplary embodiment of an off-line ME system 180 is shown. The ME system 180 comprises a removable holding container 185 (e.g., a drum with a quick-release connector) that is attached to the ME unit 130 via a process line 190. A rectifier 192 is coupled to anode and cathodes of the ME unit 130 to provide them with appropriate electrical charge.

The holding container 185 is designed to temporarily store process solution with the chemical element. The holding container 185 can be substituted with another container once the process solution has been processed. The ME unit 130 receives and processes the process solution contained in the holding container 185. The resultant purified solution may be transferred via a process line 195 while separated chemical elements may be routed over a different process line 196 or stored in a tank for later retrieval.

Referring now to FIG. 2, an exemplary embodiment of the ME unit 130 is shown. Being implemented with a “closed frame” design for this embodiment, ME unit 130 comprises at least one cell formed by a plurality of cell frames 200 and 210, which are separated by a membrane 220 and at least two screen spacers 230 and 240. A first screen spacer 230 is interposed between cell frame 200 and membrane 220 while a second screen spacer 240 is interposed between cell frame 210 and membrane 220.

For this embodiment, each cell frame 200 and 210 is made of a material that mitigates corrosive effects caused by the process solution as well as harmful effects caused by temperature variations. Examples of the type of material forming the cell frames 200 and 210 include, but are not limited or restricted to PVC, polypropylene and PVDF.

Moreover, each cell frame 200 and 210 is polygon shaped with a thickness (D1, D2) approximately ranging between one-half of an inch (½″) to one inch (1″). The thickness of each cell frame 200 or 210 may vary for industrial applications. This thickness may affect the overall system performance as well as provide appropriate mechanical stability.

As further shown in FIG. 2, each cell frame 200 and 210 features a perimeter 201 and 211 and a compartment 202 and 212, respectively. The collective depth of the compartments 202 and 212 is sufficient to house, at a minimum, anode and cathode components, at least one membrane 220 and optional screen spacers 230 and 240.

For this embodiment of the invention, a first cell frame 200 is configured with the compartment 202 to contain an anode 260 adapted with a negative voltage (referred to as an “anode cell frame”). The anode cell frame 200 comprises an in-flow port 204 positioned along its perimeter 201. For example, an in-flow port 204 may be positioned at a first side edge 205 near a top edge 207 of the anode cell frame 200. This allows fluid (e.g., process solution in one embodiment) to flow into the anode cell frame 200. An out-flow port (not shown) is positioned at a second side edge 206 near a bottom edge 208 of the anode cell frame 200. These ports allow fluid (e.g., purified solution) to flow into and out of the anode cell frame 200.

For this embodiment of the invention, at least one sidewall 209 of the anode cell frame 200 is either transparent or perhaps translucent. This provides an ability to view internal components and operations within the anode cell frame 200. For instance, where the sidewall 209 is made of a clear PVC material, a person can shine a light into the anode cell frame 200 for inspection purposes during maintenance of the ME unit 130.

As further shown in FIG. 2, a second cell frame 210 is configured with the compartment 212 to contain a cathode 400 (hereinafter referred to as a “cathode cell frame”). The cathode 400 receives a negative voltage from an external source (e.g., rectifier 192 of FIG. 1B).

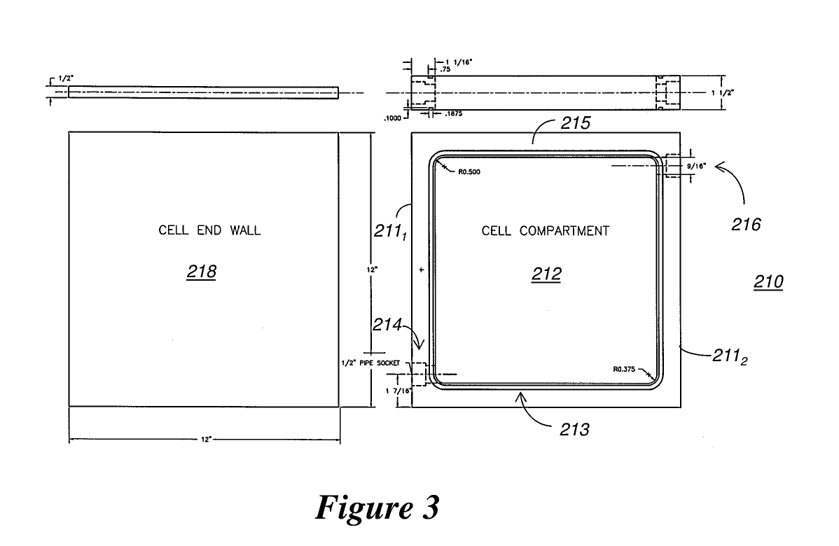

With respect to cathode cell frame 210, as shown in FIGS. 2 and 3, an in-flow port 214 is positioned along a perimeter (e.g., side edge 211₁) of the cathode cell frame 210 near a bottom edge 213 of the cell frame 210 as shown in FIG. 3. The in-flow port 214 allows fluid (e.g., process solution in one embodiment) to flow into the cathode cell frame 210. An out-flow port 216 is positioned at a side edge 211₂ near a top edge 215 of the cathode cell frame 210, which allows fluid (e.g., purified solution) to flow out therefrom. The positioning of the out-flow port 216 above the in-flow port 214 is designed to substantially mitigate air bubbles.

For this embodiment of the invention, at least one sidewall 218 of cathode cell frame 210 is either transparent or perhaps translucent. This provides an ability to view internal components and operations within the cathode cell frame 210. For instance, where the sidewall 218 is made of a clear PVC material, a person can shine a light into the cathode cell frame 210 for inspection purposes for maintenance of the ME unit 130. For example, one can check whether electrodes of the cell frame 210 are corroded.

It is contemplated that the positioning of in-flow ports and out-flow ports along side edges may alternate between neighboring cell frames. For instance, the cathode cell frame 210 features the out-flow port 216 positioned near the top edge 215 of the cathode cell frame 210. For the neighboring anode frame 200, however, the out-flow port (not shown) is positioned near the bottom edge 208 while the in-flow port 204 is positioned near the top edge 207. This provides a cross flow condition for the fluid being processed.

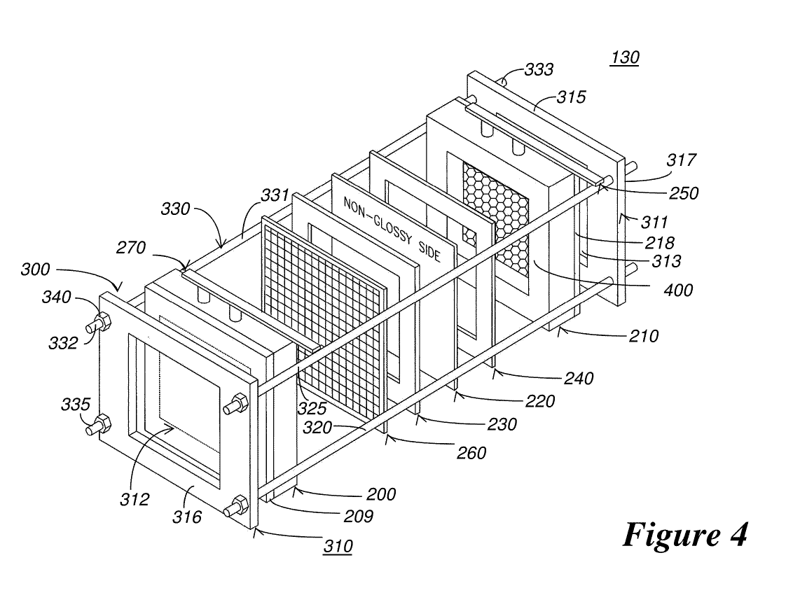

The ME unit 130 is physically stabilized using two end frames as a clamping unit 300. As shown in FIG. 4, clamping unit 300 comprises two clamping frames 310 and 311, perhaps made of a metal such as stainless steel, placed adjacent to and generally flush against cell frames 200 and 210. In one embodiment, each of the clamping frames 310 and 311 features a center opening 312 and 313, respectively. These openings 312 and 313 are situated over the transparent or translucent sidewalls 209 and 218, respectively.

Each of the clamping frames 310 and 311 also features apertures. Each aperture of the clamping frame 310 is positioned to be aligned with an aperture of the clamping frame 311. The apertures of the clamping frames 310 and 311 may be predrilled or may be made at the time of assembly.

Fastening rods 320, 325, 330, 335 are inserted through the apertures with fastening components 340 placed at each end or at least one end of the fastening rods 320, 325, 330 and 335. The fastening components 340 may are rotated in a clockwise direction so that clamping frames 310 and 311 are forced closer together and sandwich cell frames 200, 210, spacers 230, 240 and membranes 220 until the ME cell is sealed and stabilized. It is contemplated, however, that the clamping frames 310 and 311 may be forced closer together by hydraulic equipment in lieu of fastening components.

Herein, according to one embodiment of the invention, each rod (e.g., rod 330) comprises a body portion 331, a first end 332 and a second end 333. A first end 332 is sized with a diameter less than the diameter of one of the apertures formed within the clamping frame 310. Inserted through this aperture, the first end 332 of rod 330 may be threaded to receive the fastening component 340. Illustrative examples of a “fastening component” include, but are not limited or restricted to different types of hardware such as a threaded nut, wing nut, lock nut or the like. The fastening component 340 is used to tighten and pull together the clamping frames 310 and 320.

It is contemplated, however, that the fastening component 340 may be a fastener that does not require threaded ends of rods 320, 325, 330 and 335. As a result, a force is applied to a front surfaces 316 and 317 of the clamping frames 310 and 311, where the fastening components 340 are slid on the rods 320, 325, 330 and 335 and secured by soldering, contraction of an opening within the fastening components 340 or the like.

The second end 333 of rod 330 may be sized with a diameter greater than the diameter of its corresponding aperture placed in the second clamping frame 311. Thus, the first end 332 and the body portion 331 of rod 330 is inserted through the aperture until the second end 333 engages with the wall forming the aperture. Alternatively, however, the second end 333 may be sized with a diameter less than the diameter of its corresponding aperture. Hence, another fastening component would be placed thereon.

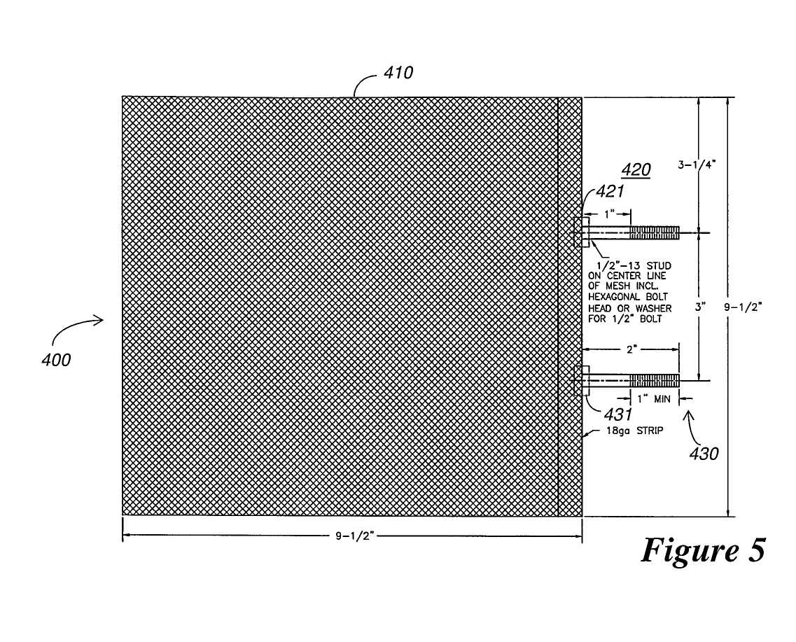

Referring now to FIGS. 2 and 5, cathode 400 comprises a material formed as a mesh screen 410. The material is referred to as “expanded metal,” such as, for example, platinum, stainless steel or a base material electroplated or cladded with a conductive material (e.g., platinum plated titanium, iridium plated titanium, iridium oxide coated titanium, etc.). Of course, the cathode 400 may be deployed in a variety of embodiments besides as an expanded metal screen cathode, such as a filling (e.g., negatively charged metal or carbon beads) for example.

Herein, for this embodiment, cathode 400 comprises a plurality of electrical connectors 420 and 430, a portion 421, 431 of which are made of expanded metal. These connectors 420 and 430 protrude from the mesh screen 410 for coupling with a bus bar 250 on a top edge 215 of the cell frame 210 as shown in FIG. 2. The bus bar 250 includes connectors 251 and 252 sized to receive connectors 420 and 430 for attachment thereto.

For this embodiment of the invention, as shown in FIG. 2, anode cell frame 200 comprises the anode 260, which is configured as a self-supporting screen and placed between screen spacer 230 and housed within the compartment 202 of anode cell frame 200. The screen is self-supporting by the inclusion of a frame 261 bordering a perimeter of screening material 262. A bus bar 270 is attached to the anode 260 via connectors as used for attachment of the cathode 400. However, in this embodiment, the connectors may need to be of greater length than connectors 420 and 430 of FIG. 5.

Referring still to FIG. 2, the cell frames 200 and 210 of the ME unit 130 are completely closed and sealed to the outside, so no off-gassing is possible when the electrodes are energized and electrochemical reactions occur in the inside of the cell frames 200 and 210 at the electrodes.

Each spacer 230 and 240 includes a gasket structure and is made from a material that provides good mechanical and stability properties at the interface between gasket and cell frame. The one-piece spacer design provides excellent seal performance because it (1) includes a one-piece gasket that is located between cell frame 200/210 and the membrane 220 on each side of the spacer assembly, (2) provides an optimized blend of flexibility and sealing capabilities for fluid separation, and (3) provides excellent pressure distribution due to the “one-piece” nature of the spacer assembly.

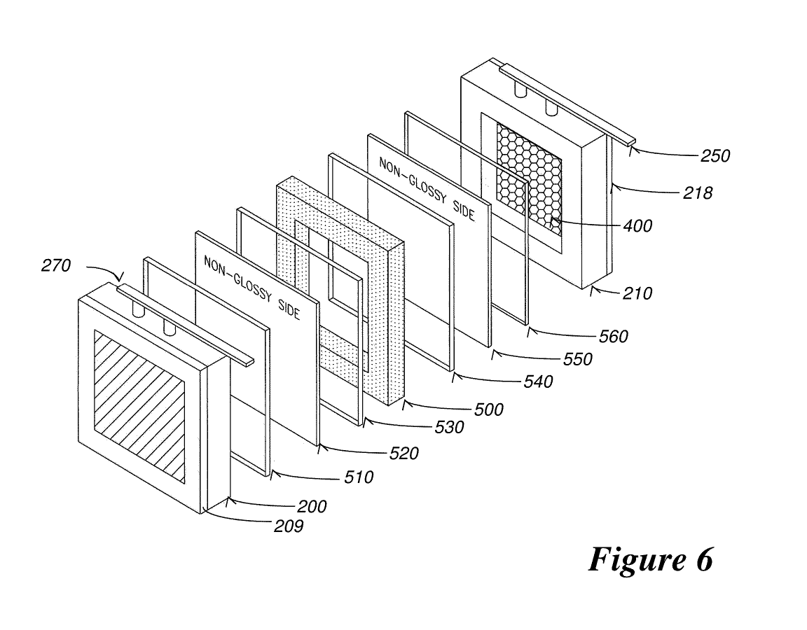

In another embodiment, as shown in FIG. 6, a second exemplary embodiment of the ME unit 130 is shown. The ME unit 130 comprises the anode cell frame 200 and the cathode cell frame 210 separated by a third non-conductive frame (referred to as “PVC frame”) 500. The anode cell frame 200 neighbors a first screen spacer 510. A first membrane 520 is interposed between the first screen spacer 510 and a second screen spacer 530, which neighbors PVC frame 500. PVC frame 500 is similar in construction to cell frames 200 and 210 but does not include electrodes. This multiple membrane configuration with additional components (e.g., spacer 540, second membrane, spacer 560) may be repeated to support an additional membrane between PVC frame 500 and cathode cell frame 210. It is noted that these additional components may be repeated for additional cell frames or cells.

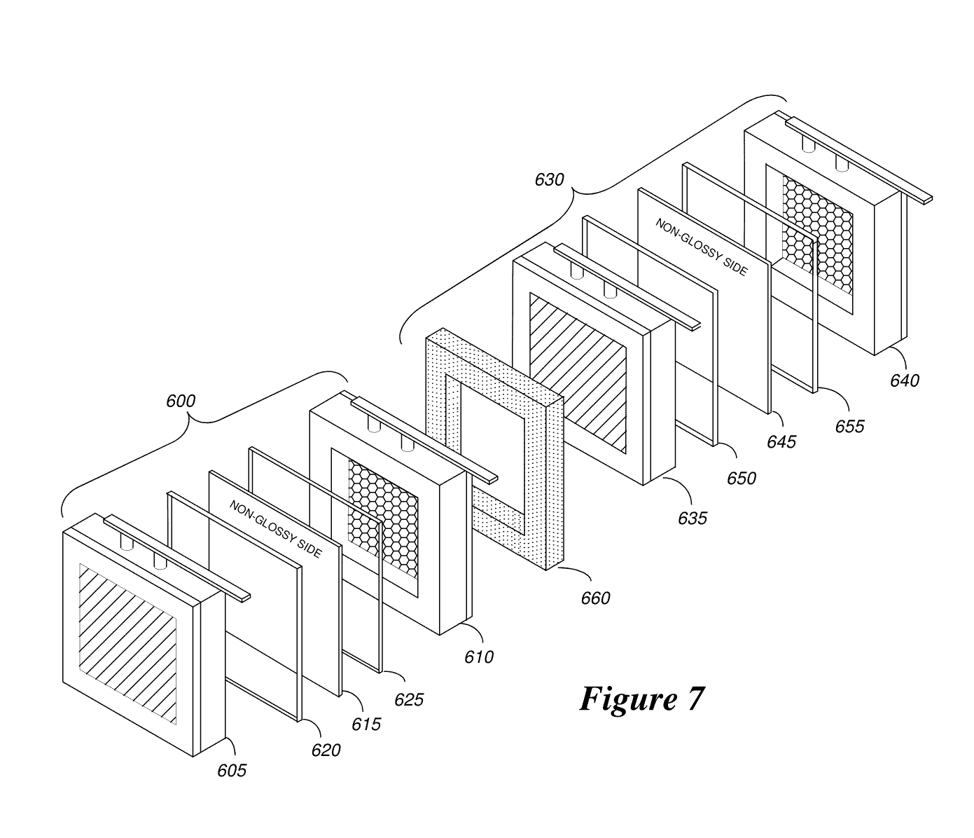

For instance, as shown in FIG. 7, it is contemplated that multiple cells may be interconnected through PVC frames. As an illustration, a first cell 600 comprises an anode cell frame 605, a cathode cell frame 610, and a first membrane 615. Spacers 620 and/or 625 may be optionally provided between the first membrane 615 and the respective cell frames 605 and 610. A second cell 630 comprises an anode cell frame 635, a cathode cell frame 640, a second membrane 645 and optional spacers 650 and/or 655. A PVC frame 660 is interposed between the cells 600 and 630 so that fluid may be exchanged between the cell frames and the cells themselves in a cross flow orientation as described in FIG. 2.

As provided by the ME unit 130, some of the embodiments illustrated above, functionality realized by the invention include optimized fluid mixing and flux for high ion transport efficiency. This is accomplished by the architectures set forth above, which generally minimize the distance between electrode and membrane and provide a square-oriented, angled-screen design of the spacer placed between the electrode and the membrane. By minimizing the distance, optimum conductance may be achieved, and thus, high mass transfer. The square, angled-screen also provides for higher mass transfer performance and spreads the pressure applied by the in-flow of process solution.

The architecture set forth above provides optimized cell compartments and operating conditions, which allow for high current mass transfer and performance. This may be accomplished through (1) high linear fluid velocity between membranes and electrodes which allow for improved ion transportation rate and low diffusion resistance at the membrane surfaces; (2) optimized fluid dynamics and high flow velocity provide high ionic concentrations in cell compartments; and (3) high ionic concentrations allow high diffusion rates through membranes; and thus high performance. Also, a completely closed cell frame design avoids off-gassing.

Additionally, the one-piece spacer design provides for excellent seal performance because it is located between a cell frame and membrane on each side of the spacer assembly. The one-piece spacer provides optimized blend of flexibility and sealing capabilities for fluid separation as well as optimized pressure distribution due to the “one-piece” nature.

With respect to cell frame and ME unit architectures, one embodiment of the invention provides maximum operational flexibility because different specific ion exchange membranes can be used such as monovalent ion selective, bivalent ion selective and multivalent selective anion and/or cation exchange membranes. Also, the ME unit allows for use of different screen type (expanded metal) and sheet electrodes such as platinum, platinum plated titanium, platinum cladded titanium, iridium plated titanium, iridium oxide coated titanium, and carbon. Also, the cell frames can be made of any of a number of different materials such as PVC, Polypropylene and PVDF.

In summary, optimized fluid dynamics (high Re number), optimized electrode distance (high ionic conductance) and optimized cell flow rate (high mass transport rate) result in an enhanced frame design and performance, and significantly reduced leakage characteristics.

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. An apparatus comprising:
a first cell frame including a first compartment housing an anode; and
a second cell frame including a second compartment housing a cathode,
wherein the first compartment and the second compartment collectively form a compartment to additionally house at least (i) a first membrane positioned between the anode and the cathode and (ii) a first spacer positioned between the cathode of the second cell frame and the first membrane.

2. The apparatus of claim 1 further comprising a second spacer positioned between the anode and the first membrane.

3. The apparatus of claim 2 further comprising a third cell frame including an anode, a fourth cell frame including a cathode, and a non-conductive frame interposed between (1) the first cell frame and the second cell frame, and (2) the third cell frame and the fourth cell frame.

4. The apparatus of claim 3, wherein a sidewall of both the first cell frame and the fourth cell frame is either translucent or transparent.

5. The apparatus of claim 1 being a membrane electrolysis (ME) unit to recover chemical elements.

6. A system comprising:
a unit containing a process solution including chemical elements to be recovered;
a process line in fluid communications with the unit; and
a membrane electrolysis (ME) unit in fluid communications with the unit via the process line, the ME unit comprising
a first cell frame including a first compartment that houses an anode, and
a second cell frame including a second compartment that houses a cathode and faces the first compartment, wherein the first compartment and the second compartment collectively form a compartment to additionally house (i) at least a first membrane positioned between the anode and the cathode, (ii) a first spacer positioned between the cathode of the second cell frame and the first membrane, and (iii) a second spacer positioned between the anode of the first cell frame and the first membrane.

7. The system of claim 6, wherein the unit comprises a holding container with a connector for adaptation to the process line.
